(19) United States
(12) Patent Application Publication
(10) Pub. No.: US 2016/0114486 A1
(43) Pub. Date: Apr. 28, 2016

(54) METHOD FOR AUTOMATICALLY RECALIBRATING A ROBOTIC ARM

(71) Applicant: QUANTA STORAGE INC., Taoyuan City (TW)

(72) Inventors: Chung-Hsien HUANG, Taoyuan City (TW); Shih-Jung HUANG, Taoyuan City (TW)

(73) Assignee: QUANTA STORAGE INC., Taoyuan City (TW)

(21) Appl. No.: 14/924,335

(22) Filed: Oct. 27, 2015

(30) Foreign Application Priority Data
Oct. 27, 2014 (CN) 201410584182.1

(51) Int. Cl. B25J 9/16

(52) U.S. Cl. CPC B25J 9/1692; B25J 9/1697; Y10S 901/09

(57) ABSTRACT

A method for automatically recalibrating a robotic arm is provided. Firstly, the recalibration of a robotic arm is automatically activated at a pre-determined time. Then, an eye-in-hand (EIH) camera of the robotic arm is controlled and moved to one or a plurality of pre-determined orientations to focus and capture an image of an identifiable simple pattern, which is fixed with respect to a body of the robotic arm. Then, the detecting orientation of a movable portion of the robotic arm is calculated according to the captured image, and an error between the detecting orientation and the pre-determined orientation is obtained through comparison. Lastly, the error of the robotic arm is calibrated.

This application claims the benefit of People's Republic of China application Serial No. 201410584182.1, filed Oct. 27, 2014, the subject matter of which is incorporated herein by reference.

### BACKGROUND

1. Technical Field

The invention relates in general to a method for automatically recalibrating a robotic arm, and more particularly to a method for automatically recalibrating a robotic arm at a pre-determined time and preventively calibrating the motion error of the robotic arm.

2. Related Art

Along with the rapid advance in the technology of industrial production, the visual device is used in factory automation to position the work piece and guide the robotic arm, so that the work piece can be automatically grabbed/released with high precision to increase the efficiency of rapid production of high precision. The most essential factor that affects the automatic and precise motion of the robotic arm lies in the visual device which guides the robotic arm. Therefore, how to use the visual device to calibrate the robotic arm and reduce the guiding error has become an important issue to the robotic arm.

Referring to FIG. 1, a schematic diagram of calibrating a robotic arm 10 according to the prior art is shown. According to the prior art, one end of the robotic arm 10 is fixed on a body 11, and the other end of the robotic arm 10 is connected to a movable portion 13. The robotic arm 10 can drive at least one elbow joint 12 to control the movable portion 13. The robotic arm 10 is guided by a visual device which includes an eye-to-hand (ETH) camera 14 and an eye-in-hand (EIH) camera 15. The ETH camera 14 is installed in the working environment of the robotic arm 10 for monitoring and guiding the motion of the robotic arm 10. The EIH camera 15 is normally disposed on the movable portion 13 for capturing the image in front of the movable portion 13 to closely observe the environment, so that the robotic arm 10 can be guided to approach and grab/release the work piece.

Normally, when the robotic arm 10 is installed to the production line, the robotic arm 10 needs to be calibrated to assure the precision level of operation. When calibrating the robotic arm 10, to avoid the calibration work being interfered with, firstly, the working machine 16 needs to be cleaned so that a space can be prepared for placing a calibration plate 17. A standard calibration plate 17 is a rectangular latticed structure composed of interlaced black and white cells. The calibration plate 17 is fixed in the main working area of the robotic arm 10, and there is a fixed position relationship between the calibration plate 17 and the robotic arm 10. During the calibration of the EIH camera 15, through the EIH camera 15 disposed on the movable portion 13 of the robotic arm 10, the robotic arm 10 is guided to move and drive the EIH camera 15 to approach the calibration plate 17. The EIH camera 15 further focuses and captures the image of the calibration plate 17 in different pre-determined positions and directions. The position and direction of the robotic arm 10 with respect to the calibration plate 17 are detected according to the captured image of the calibration plate 17. Different detecting positions and directions of the robotic arm 10 are calculated according to the fixed position relationship between the calibration plate 17 and the robotic arm 10. Then, the errors between the calculated detecting position and direction and the pre-determined position and direction are obtained through comparison, and the errors between the position and direction of the robotic arm 10 and that of the EIH camera 15 are calibrated. Then, the ETH camera 14 is calibrated. Lastly, the calibration plate 17 is removed, and the work piece is again placed on the working machine 16 for the robotic arm 10 to resume its precision operation.

However, after the robotic arm 10 is calibrated and has been operating for a period of time, the error of the robotic arm 10 might be increased due to temperature change in the working environment, mechanical wearing of the robotic arm 10, or the change in the relative position between the robotic arm 10 and the visual device due to the vibration and wobbling of the visual device. Since the robotic arm 10 cannot proactively detect that the error is increasing nor proactively detect the change in the relative position between the robotic arm 10 and the visual device, the user cannot foresee when the robotic arm 10 will be recalibrated. Normally, the error of the robotic arm 10 cannot be found until product defects are detected in the stage of post-production detection. However, the defected products are already manufactured. Before the complicated calibration process can be performed, the production line needs to be suspended and the working machine needs to be vacated to prepare a space for placing the calibration plate. This process is tedious and requires a lot of efforts. Therefore, the calibration of the robotic arm still has many problems to resolve.

### SUMMARY

According to an object of the present invention, a method for automatically recalibrating a robotic arm is provided. At a pre-determined time, the recalibration of a robotic arm is automatically activated to proactively detect the error of the robotic arm.

According to another object of the present invention, a method for automatically recalibrating a robotic arm is provided. A robotic arm is moved to a pre-determined orientation to capture an image of an identifiable simple pattern which is fixed with respect to the robotic arm for quickly recalibrating the error of the robotic arm.

According to an alternate object of the present invention, a method for automatically recalibrating a robotic arm is provided. When the detected error of the robotic arm is over a pre-determined value, a recalibration notice is preventively sent to maintain the precision level of the robotic arm.

To achieve the above objects, the method for automatically recalibrating a robotic arm of the present invention includes following steps. Firstly, the recalibration of a robotic arm is automatically activated at a pre-determined time. Then, an EIH camera of the robotic arm is controlled and moved to one or a plurality of pre-determined orientations to focus and capture an image of an identifiable simple pattern, which is fixed with respect to a body of the robotic arm. Then, the detecting orientation of a movable portion of the robotic arm is calculated according to the captured image, and the error between the detecting orientation and the pre-determined orientation is obtained through comparison. Lastly, the error of the robotic arm is calibrated.

According to the method for automatically recalibrating a robotic arm of the present invention, the pre-determined time for recalibration is set at the startup, shutdown or gap time of the robotic arm. The simple pattern is fixed on the body of the robotic arm or on the working machine installed in the working environment of the robotic arm. Based on the error obtained through comparison, if it is determined that the error is greater than a pre-determined value, then a recalibration notice is sent for arrangement of work suspension and the recalibration of the robotic arm. If it is determined that the error is not greater than the pre-determined value, then the error of the robotic arm is recalibrated continuously.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of calibrating a robotic arm according to the prior art.

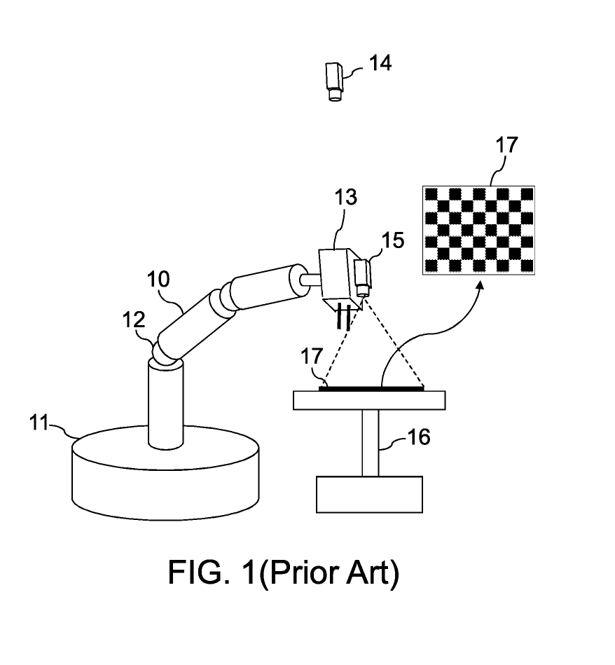

FIG. 2 is a schematic diagram of recalibrating a robotic arm according to the present invention.

FIG. 3 a schematic diagram of recalibrating a robotic arm according to another embodiment of the present invention.

FIG. 4 is a flowchart of a method for the present invention the robotic arm for automatically recalibrating a robotic arm.

FIG. 5 is a flowchart of for automatically recalibrating a robotic arm according to another embodiment of the present invention.

### DETAILED DESCRIPTION

The technical methods adopted to achieve the above objects of the present invention and the consequent effects are disclosed in a number of preferred embodiments below with reference to the accompanying drawings.

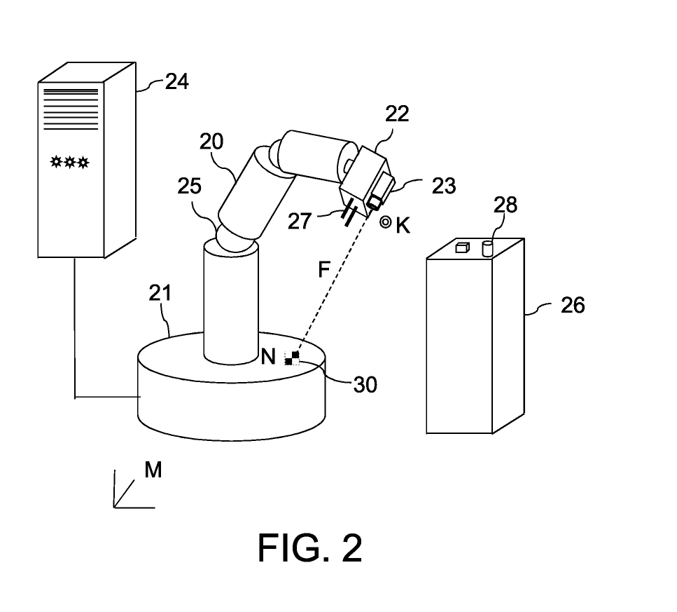

Referring to FIG. 2, a schematic diagram of recalibrating a robotic arm according to the present invention is shown. In the present invention, the calibrated robotic arm 20 installed in the working environment is recalibrated, wherein one end of the robotic arm 20 is connected a body 21 which is fixed and has an arm reference coordinate M, and the other end of the robotic arm 20 is connected to a movable portion 22 on which an EIH camera 23 is disposed. The control device 24 of the robotic arm 20 instructs the EIH camera 23 to capture an image. Based on the analysis and image processing of the captured image, the control device 24 further controls and drives a plurality of elbow joints 25 of the robotic arm 20 to guide the movable portion 22 to approach the work piece 28 placed on the working machine 26 installed in the working environment. The clamping device 27 grabs/releases the work piece 28 for the assembly of product.

In the present invention, a simple pattern 30 is further disposed on the body 21 of the robotic arm 20. Since the body 21 of the robotic arm 20 is fixed with respect to the robotic arm 20, the simple pattern 30 has an absolute position coordinate N in the arm reference coordinate M. After the robotic arm 20 drives the EIH camera 23 to a pre-determined orientation K, the EIH camera 23 focuses and captures an image of the simple pattern 30 for the recalibration of the robotic arm 20.

During the recalibration of the present invention, the control device 24 controls the robotic arm 20 to automatically activate recalibration at a pre-determined time. In the present embodiment, the pre-determined time is set at the time for example when the robotic arm 20 is started up. When the control device 24 of the present invention detects that the robotic arm 20 is started up, the control device 24 automatically activates the recalibration of the robotic arm 20 immediately. The control device 24 controls and moves the robotic arm 20 to drive the EIH camera 23 to the pre-determined orientation K. Then, the EIH camera 23 focuses and captures an image of the simple pattern 30 located at the position coordinate N. The control device 24 further processes and analyzes the captured image to obtain a relative orientation F between the movable portion 22 of the robotic arm 20 and the simple pattern 30. The detecting orientation of the actual location of the movable portion 22 can be calculated according to the position coordinate N of the simple pattern 30 and the relative orientation F. The error between the detecting orientation and the pre-determined orientation K is obtained through comparison. Then, the determined motion error of the robotic arm 20 is recalibrated.

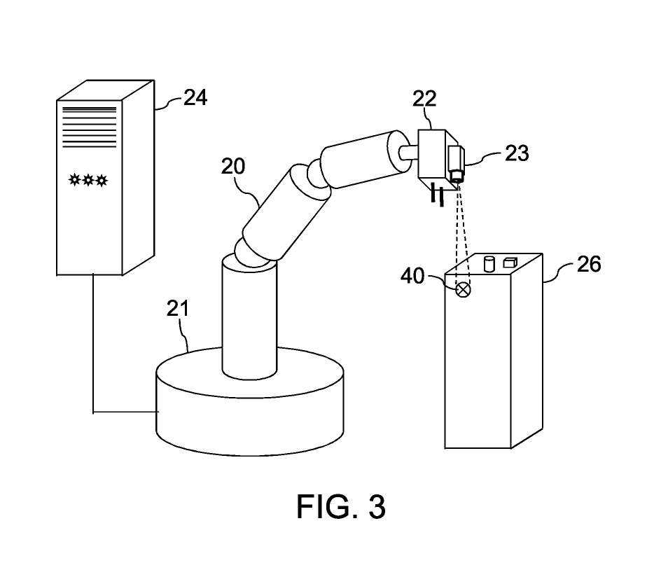

Since the present invention only performs recalibration at one or a plurality of specific pre-determined orientations, the calibration plate can adopt a simple pattern occupying smaller space, so that the recalibration can be quickly completed to cooperate with the operation of the production line. Refer to FIG. 3. The simple pattern of the present invention can be exemplified by a different but identifiable simple pattern 40, which is installed in a working environment fixed with respect to the arm reference coordinate M. For example, the simple pattern 40 is placed on the working machine 26. The simple pattern 40 can also achieve the object of quick detection for the recalibration of the present invention. Furthermore, as described above in the present invention, the pre-determined time for recalibration can be set at the time when the robotic arm is started up to perform the recalibration. Similarly, the object of recalibration of the present invention can also be achieved by setting the pre-determined time for recalibration at the time not affecting the normal operation of the production line. For example, the pre-determined time can be set at the shutdown or gap time of the robotic arm.

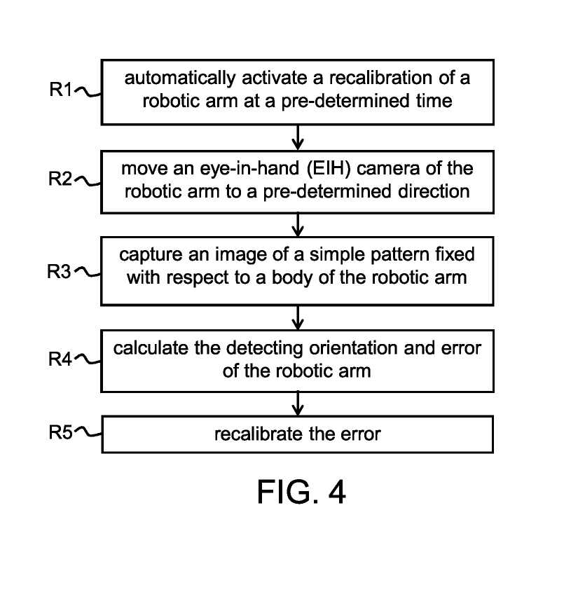

Referring to FIG. 4, a flowchart of a method for the present invention the robotic arm for automatically recalibrating a robotic arm is shown. Detailed steps of automatically activating the robotic arm and then recalibrating it are disclosed below. Firstly, the method begins at step R1, the recalibration of a robotic arm is automatically activated at a pre-determined time. Next, the method proceeds to step R2, an EIH camera of the robotic arm is controlled and moved to a pre-determined orientation. Then, the method proceeds to step R3, an image of a simple pattern placed on a body of the robotic arm is focused and captured. Then, the method proceeds to step R4, the detecting orientation of a movable portion of the robotic arm is calculated according to the captured image, and the error between the detecting orientation and the pre-determined orientation is obtained through comparison. Then, the method proceeds to step R5, the error between the detecting orientation and the pre-determined orientation is calibrated to complete the recalibration of the robotic arm.

According to the method for automatically recalibrating a robotic arm of the present invention, the object of recalibrating the error of the robotic arm is achieved through following steps. The recalibration of a robotic arm is automatically activated at a pre-determined time. A robotic arm is moved to one or more pre-determined orientations. An image of an identifiable simple pattern fixed with respect to the robotic arm is captured. The error of the robotic arm is proactively detected, and, without affecting the operation of the production line, the error of the robotic arm is quickly calibrated.

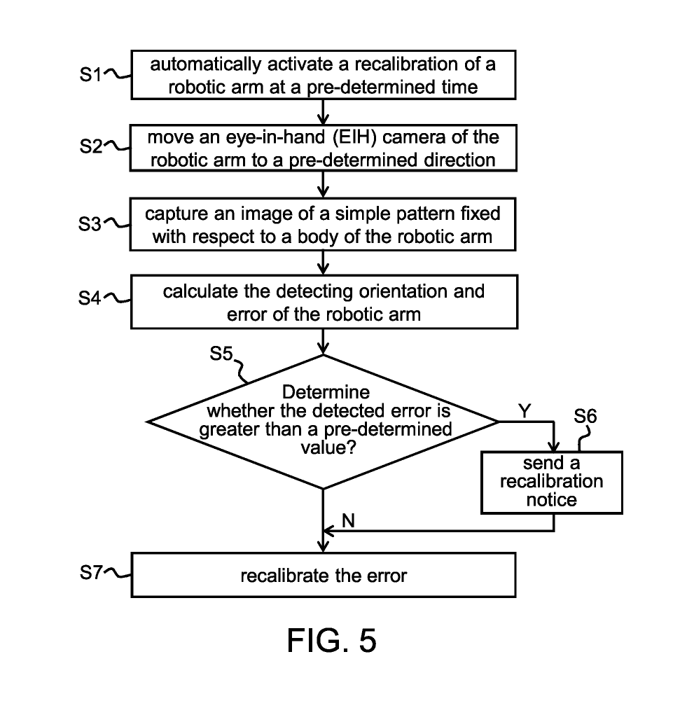

Referring to FIG. 5, a flowchart of for automatically recalibrating a robotic arm according to another embodiment of the present invention is shown. In the present embodiment, recalibration is automatically activated by the robotic arm of the previous embodiment. However, the previous embodiment cannot cover the calibration in all orientations, and can only detect errors in one or more specific orientations such that recalibration can be quickly performed and the operation of the entire production line will not be affected. If an abnormal error is detected in one or more specific orientations, it is very likely that the robotic arm has severe error in each orientation, and such error cannot be fixed by simple recalibration. In the present embodiment, if the robotic arm of the previous embodiment is detected to have an abnormal error in one or more specific orientations, a recalibration notice is sent for the arrangement of work suspension and the recalibration of the robotic arm.

The method of automatically recalibrating a robotic arm according to the present embodiment is disclosed in following steps. Firstly, the method begins at step S1, the recalibration of a robotic arm is automatically activated at a pre-determined time. Next, the method proceeds to step S2, an EIH camera of the robotic arm is controlled and moved to a pre-determined orientation. Then, the method proceeds to step S3, an image of an identifiable simple pattern, which is fixed with respect to the body of the robotic arm, is focused and captured. Then, the method proceeds to step S4, the detecting orientation of a movable portion of the robotic arm is calculated according to the captured image, and the error between the detecting orientation and the pre-determined orientation is obtained through comparison. Then, the method proceeds to step S5, whether the detected error is greater than a pre-determined value is determined. If it is determined that the error is greater than the pre-determined value, then the method proceeds to step S6. If it is determined that the error is not greater than the pre-determined value, then the method proceeds to step S7. In step S6, a recalibration notice is sent for the arrangement of work suspension and the recalibration of the robotic arm. In step S7, the error of the robotic arm between the detecting orientation and the pre-determined orientation is calibrated to complete the recalibration of the robotic arm.

According to the method for automatically recalibrating a robotic arm of the present invention, if it is determined that the detected error of the robotic arm is greater than a pre-determined value, a recalibration notice is preventively sent for the arrangement of work suspension and the recalibration of the robotic arm, such that the precision of the robotic arm can be achieved.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for automatically recalibrating a robotic arm, wherein the method comprises steps of:
automatically activating a recalibration of a robotic arm at a pre-determined time;
controlling and moving an eye-in-hand (EIH) camera of the robotic arm to a pre-determined orientation;
focusing and capturing an image of a simple pattern fixed with respect to a body of the robotic arm;
calculating a detecting orientation of a movable portion of the robotic arm according to the image captured and obtaining an error between the detecting orientation and the pre-determined orientation through comparison;
recalibrating the error of the robotic arm.

2. The method for automatically recalibrating the robotic arm according to claim 1, wherein the pre-determined time for recalibration is set at the startup, shutdown or gap time of the robotic arm.

3. The method for automatically recalibrating the robotic arm according to claim 1, wherein the pre-determined orientation is one or a plurality of pre-determined detecting orientations.

4. The method for automatically recalibrating the robotic arm according to claim 1, wherein the simple pattern is an identifiable simple pattern.

5. The method for automatically recalibrating the robotic arm according to claim 1, wherein the simple pattern is fixed on the body of the robotic arm.

6. The method for automatically recalibrating the robotic arm according to claim 1, wherein the simple pattern is fixed in a working environment of the robotic arm.

7. The method for automatically recalibrating the robotic arm according to claim 6, wherein the simple pattern is fixed on a working machine installed in the working environment of the robotic arm.

8. The method for automatically recalibrating the robotic arm according to claim 1, wherein if it is determined that the error is greater than a pre-determined value, then a recalibration notice is sent for arrangement of work suspension and the recalibration of the robotic arm.

9. The method for automatically recalibrating the robotic arm according to claim 8, wherein after the recalibration notice is sent, the error of the robotic arm is recalibrated continuously.

10. The method for automatically recalibrating the robotic arm according to claim 1, wherein if it is determined that the error is not greater than a pre-determined value, then the error of the robotic arm is recalibrated directly.
